(19) United States
(12) Patent Application Publication
(10) Pub. No.: US 2012/0221964 A1
(43) Pub. Date: Aug. 30, 2012

(54) OPINION FEEDBACK IN A COMPUTER-BASED SOCIAL NETWORK

(75) Inventor: Shlomo Markel, Haifa (IL)

(73) Assignee: BROADCOM CORPORATION, IRVINE, CA (US)

(21) Appl. No.: 13/050,503

(22) Filed: Mar. 17, 2011

Related U.S. Application Data
(60) Provisional application No. 61/446,907, filed on Feb. 25, 2011.

(51) Int. Cl. G06F 3/01

(52) U.S. Cl. 715/753

(57) ABSTRACT

A method for soliciting opinion feedback in a computer-based social network in which the computer-based social network is populated by a set of users defined by social profiles indicating shared interests with an individual. The method includes displaying, in substantially real-time, a mirrored-representation of an individual based upon a captured digital image of the individual. The individual identifies an item of a plurality of items, wherein the mirrored-representation mimics a motion gesture of the individual to identify the item. The individual adorns the mirrored-representation with the identified item of the plurality of items, uploads the adorned mirrored-representation to the computer-based social network. The individual receives, in response, opinion feedback relating to the adorned mirrored-representation from at least a subset of the set of users.

The present U.S. Utility Patent Application claims priority pursuant to 35 U.S.C. §119(e) to the following U.S. Provisional Patent Application 61/446,907, entitled “OPINION FEEDBACK IN A COMPUTER-BASED SOCIAL NETWORK,” (Attorney Docket No. BP22119), filed Feb. 25, 2011, pending, which is hereby incorporated herein by reference in its entirety and made part of the present U.S. Utility Patent Application for all purposes.

### BACKGROUND

1. Field of the Invention

The present invention relates to soliciting opinion feedback in a computer-based social network, and more particularly, to soliciting a variety of opinion feedback in a computer-based social network to an adorned representation of an individual in a virtual room.

2. Description of the Related Art

Social network services focus on building and reflecting social networks or social relations among individuals having shared interests and/or activities. A social network service generally has included a profile representation of an individual, the individual's social links, and other similar information. The social network may also provide services that allow individuals to interact over the Internet, such as e-mail and instant messaging.

The main types of social networking services have been based on category places (such as, former school-year and/or classmates), on the ability to connect and/or reconnect with friends and acquaintances (such as through self-description pages and/or profiles) and on a recommendation system based upon trust.

Interaction in a computer-based network, however, has been limited to the context of text-based communication. A need exists for further interaction, such as soliciting a variety of feedback based on a visual depiction of an individual adorned with items, such as clothing, clothing accessories, and space arrangement based on furniture selection and accents.

### BRIEF SUMMARY OF THE INVENTION

The present invention is directed to apparatus and methods of operation that are further described in the following Brief Description of the Drawings, the Detailed Description of the Drawings, and the claims. Other features and advantages of the present invention will become apparent from the following detailed description of the drawings made with reference to the accompanying drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a functional block diagram illustrating a communication system that includes a set-top box device, and an image capture device, and a display;

FIG. 2 is a schematic block diagram illustrating an architecture of a set-top box including a processing module and a memory according to an embodiment of the present invention;

FIG. 3 is an illustration of a display screen having a first graphic user interface (GUI) and a second GUI according to an embodiment of the present invention;

FIG. 4 is an illustration of a display screen having a GUI for a computer-based social network for opinion feedback according to an embodiment of the present invention;

FIG. 5 illustrates a method for soliciting opinion feedback in a computer-based social network according to an embodiment of the present invention; and

FIG. 6 illustrates a method for defining a graphics-based object for an identified item according to an embodiment of the present invention.

### DETAILED DESCRIPTION OF THE DRAWINGS

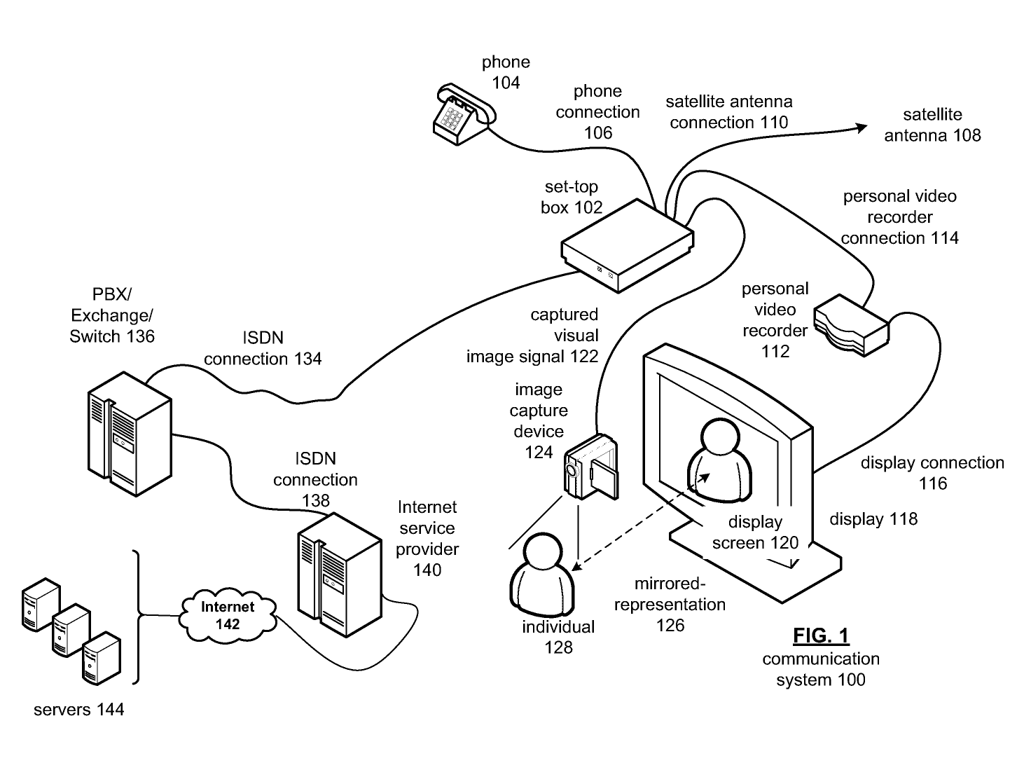

Referring to FIG. 1, the communication system 100 provides an apparatus and method for soliciting opinion feedback in a computer-based social network. The computer-based social network is populated by a set of users defined by user profiles indicating shared interests with an individual.

FIG. 1 is a functional block diagram that illustrates a communication system 100 that includes a set-top box 102, an image capture device 124, and a display 118. The communication system 100 provides communication capability via the Internet 142 and program content via satellite antenna 100.

The set-top box 102 is operably coupled to a phone 104 by a phone connection 106, which may be Voice-over-Internet Protocol (VoIP) based, PSTN based, et cetera, and to a satellite antenna 108 by a satellite antenna connection 110 to provide viewing content and/or Internet connectivity.

The set-top box 102 couples to the display 118, which includes a display screen 120, through a personal video recorder 112 by personal video recorder connection 114 and display connection 116. The personal video recorder 112 records video in a digital format to a disk drive, universal serial bus (USB) flash drive, secure digital (SD) memory card or other mass storage device. The recorded video is then available for playback to the display screen 120.

The personal video recorder 112, shown as a separate component, may also be incorporated with the set-top box 102, and may further be provided through a multi-functional consumer electronics device (CED). For example, such CEDs include portable media players (PMP) with recording facility, personal media recorder (PMR) as camcorders that record onto memory cards), software for personal computers that provide video capture and playback to and from disk, et cetera.

The set-top box 102 couples to a satellite antenna 108 through a satellite antenna connection 110 for the reception of digital television signals and/or Internet data transmission and reception. The set-top box 102 also couples to a phone through a phone connection 106 for voice communication through PSTN lines, or through Voice over IP (VoIP) communications through an Internet connection such as through the Internet 142.

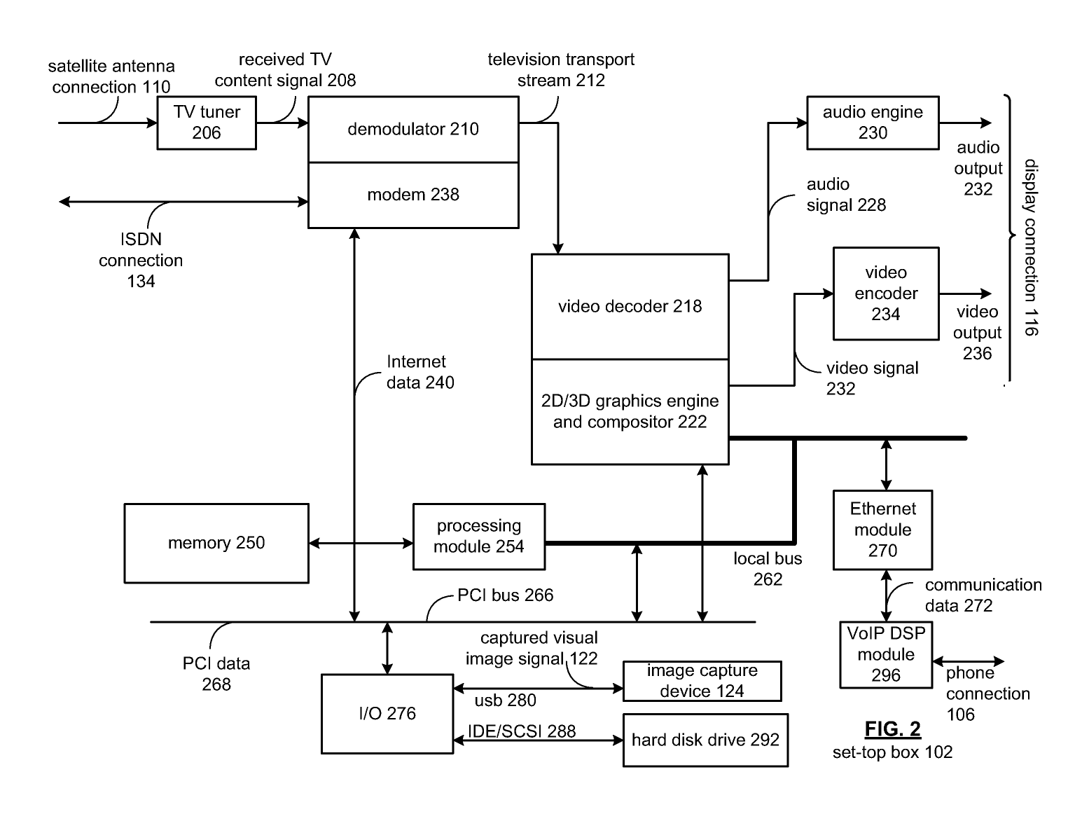

An Internet connection may also be provided via a modem, discussed in further detail with reference to FIG. 2. In the example of FIG. 1, the Internet connection is provided via a data transmission pathway provided by PBX/Exchange Switch 136 through ISDN connection 134, and to an Internet service provider 140 through ISDN connection 138. The Internet service provider 140 provides an individual 128 a connection or access to the Internet 142, and to servers 144 operated by third-party vendors, social network sites, et cetera.

The data transmission pathway may be based on Plain Old Telephone System (POTS) connection technology, Digital Subscriber Line (DSL) connection technology, Integrated Services Digital Network (ISDN) Internet, cable modem technologies, satellite-based technologies, or a combination thereof.

In operation, the set-top box 102 provides content delivery (such as television programming) by satellite and/or by connections to an Internet service provider 140. As one skilled in the art may appreciate, satellite technology may provide a content connection and an Internet connection, as may landline connections to an Internet service provider 140. Moreover, other configurations may provide access to Internet and/or content mediums via the set-top box 102. For example, the set-top box 102 receives service through telephone lines such as with WebTV, or through a cable television provider.

The set-top box 102 allows a display 118 (such as a television, computer monitor, an HDTV device, etc.) to be a user interface to the Internet 142 and also enables the display 118 to receive and decode digital television (DTV) content for display on the display screen 120.

As is discussed in greater detail with reference to FIG. 2, the set-top box 102 contains one or more microprocessors for running an operating system (for example, Linux or Windows CE), and for decoding an MPEG transport stream. The set-top box 102 includes random access memory (RAM), an MPEG decoder chip, and additional chips for audio decoding and processing.

As may be appreciated, the set-top box 102 architecture depends on the applicable digital television standard. For example, European Digital Video Broadcasting (DVB) compliant set-top boxes contain parts to decode Coded Orthogonal Frequency Division Multiplexing (COFDM) transmissions, while Advanced Television Systems Committee (ATSC)-compliant set-top boxes contain parts to decode Vestigial SideBand (VSB) transmissions. The set-top box 102 may also incorporate the personal video recorder 112 for storing recorded television broadcasts, for downloaded software, and for other applications provided by a digital television service provider.

With respect to data transmission and reception, the set-top box 102 serves as a specialized computer or consumer electronics device (CED) that can interact with the Internet 142 via the components providing the data pathway, such as the PBX/exchange switch 136 and the Internet service provider 140. For example, the set-top box 102 includes a browser (that is, a HyperText Transfer Protocol (HTTP) client) and Internet Protocol Suite providing communication protocols for the Internet 142 and other similar networks, such as the Transmission Control Protocol (TCP) and the Internet Protocol (IP).

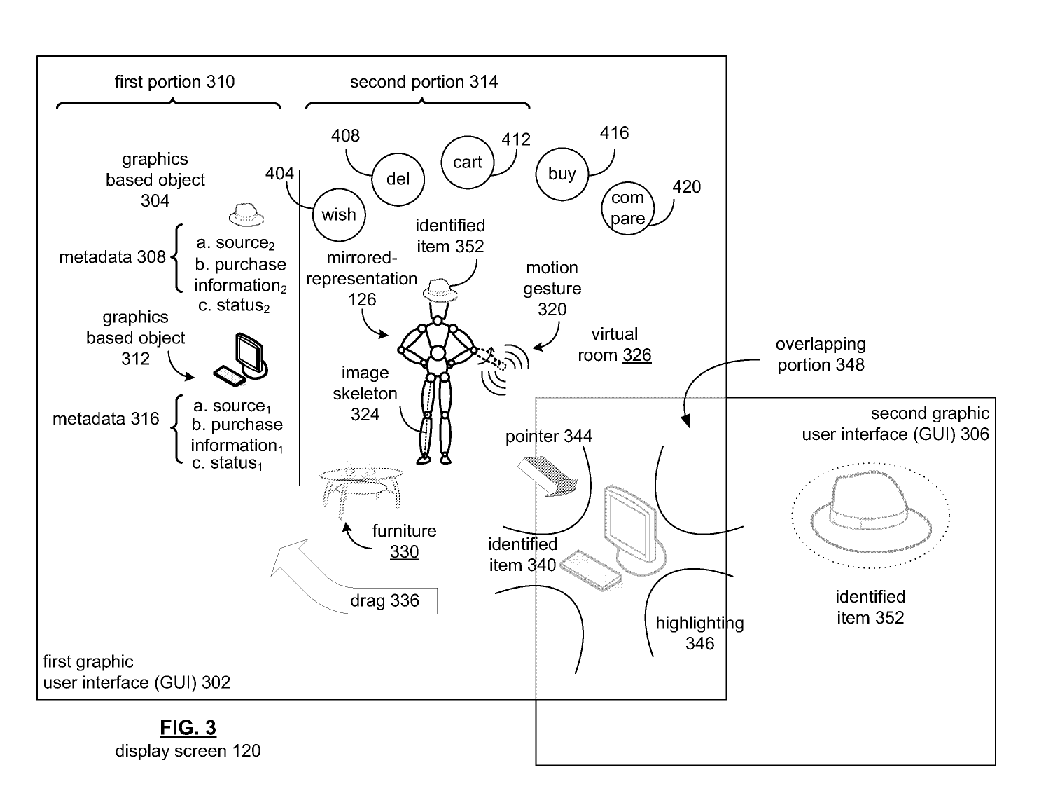

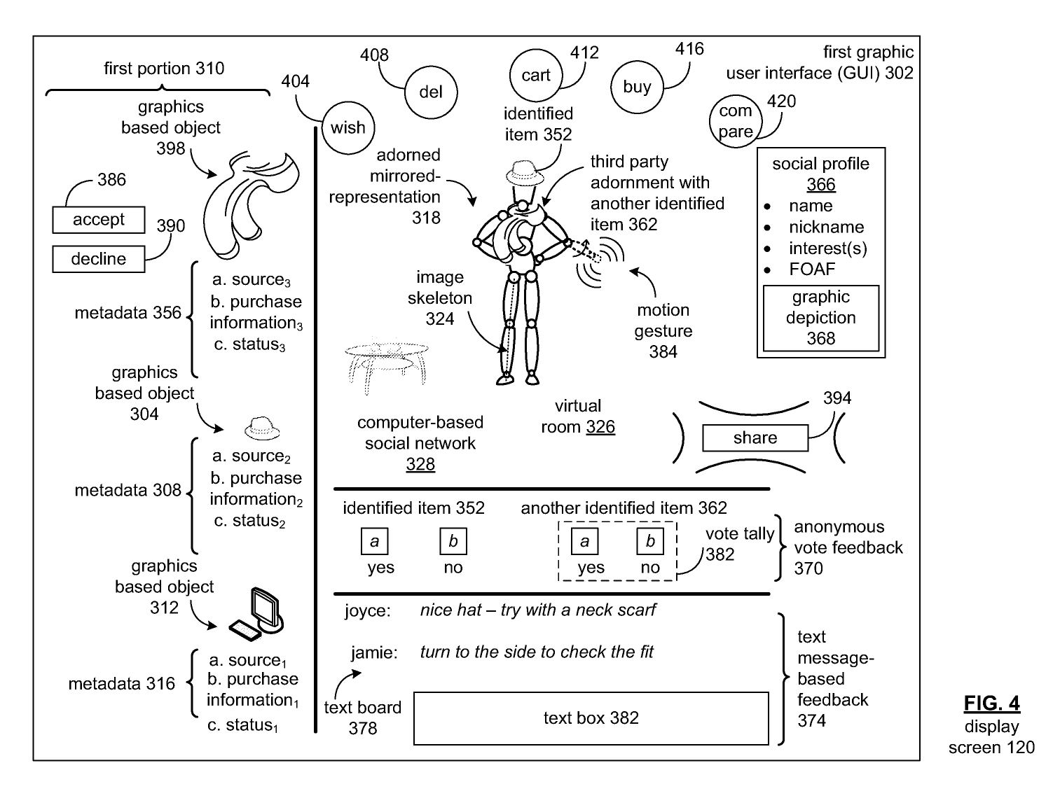

The set-top box 102 couples to an image capture device 124 to produce a captured visual image signal 122, that operates to display, in substantially real-time, a mirrored representation 126 of the individual 128. The image capture device 124 is a device capable, or modified, to record video and produce the captured visual image signal 122. Such a device may be a digital camera, a digicam, a camcorder, a mobile phone, a smart phone, a web cam, et cetera. As is discussed in further detail with reference to FIGS. 3 and 4, the set-top box 102 produces the mirrored representation 126, which is associated with a social profile of the individual 128. The set-top box 102 operates to permit the individual 128 to solicit opinion feedback based upon an adorned version of the mirrored-representation 126, such as clothing, clothing accessories, room or space furnishings, furnishing decor, et cetera.

FIG. 2 is a schematic block diagram illustrating an architecture of a set-top box 102 including a processing module 254 and a memory 250. The set-top box 102 includes a television tuner 206, which in the example provided, receives television content via the satellite antenna connection 110. The television tuner 206 provides content channel selection by an individual 128. The television tuner 206 produces a received television content signal 208 to a demodulator 210, such as a quadrature amplitude modulation (QAM) demodulator with, or without, forward error correction (FEC), et cetera.

The demodulator 210 produces a television transport stream 212 to a video decoder 218, and to a 2D/3D graphics engine and compositor 222. The television transport stream 212 is based upon a audio and video compression standard, such as MPEG-2, MPEG-4, et cetera. The video decoder 218 and the 2D/3D graphics engine and compositor operate to decode and/or decompress the television transport stream 212 and render higher quality-text and graphics to produce a video signal 232 and audio signal 228.

The audio engine 230 receives the audio signal 228 and produces audio output 232. The audio output 232 may include left and right speaker signals, and may also be in the form of digital audio signals, such as a digital audio signal in conformance with an IEC 60958 type II protocol. The video encoder 234 receives the video signal 232 and produces a video output 236. The video output 236 may include a variety of formats based upon the connection desired. For example, the video output 236 may be in an analog format, such as composite video, or digital format, such a S-Video, or a combination thereof. The audio output 232 and the video output 236 are provided to the display 118 by the display connection 116.

The modem 238 of the set-top box 102 receives and transmits data via the ISDN connection 134. The modem receives and transmits Internet data 240 with the set-top box through the Peripheral Component Interconnect (PCI) bus 266. The PCI bus 266 provides distribution and reception of the Internet data 240 through PCI data 268 to components coupled to the set-top box 102.

The local bus 262 receives PCI data 268 via the PCI bus 266. An Ethernet module 270 provides a network node to support VoIP communication via the VoIP DSP module 296. The VoIP DSP module 296 receives communications data 272 and provides the data via phone connection 106 to a VoIP capable phone 104.

The PCI bus 266 allows coupling of components and/or devices to the set-top box 102, such as a I/O 276, which in turn includes a USB 280 operably coupled to the image capture device 124, and an IDE/SCSI 288 operably coupled to a hard disk drive 292. The components and/or devices may be in the form of an integrated circuit, or planar device, fitted onto a motherboard of the set-top box 102, or as an expansion card that the PCI bus 266 receives via a PCI slot, as one of ordinary skill in the art may appreciate. The input/output 276 may include further interfaces for floppy disk controllers, serial ports, keyboard and mouse devices, game ports, infrared ports, et cetera.

The image capture device 124 provides a captured visual image signal 122 to the 2D/3D graphics engine and compositor 222 via the I/O 276 and the PCI bus 266. The 2D/3D graphics engine and compositor 222 operates to generate a mirrored-representation of the image from the captured visual image signal 122.

The 2D/3D graphics engine and compositor 222 generate the video signal 232 such that the mirrored image based upon the captured visual image signal 122 is composited with other aspects of a graphic user interface, as explained in further detail with respect to FIGS. 3 and 4. Further, as based upon an individual selection, the individual may be presented in a virtual set based upon compositing backgrounds. Further, the 2D/3D graphics engine and compositor supports movement of the user within the virtual space while the computer-generated environment changes in real time to maintain correct relationships between the subjects, and the virtual background. In this manner, an individual may generate a composited set with full-size and scaled representations within the space.

The set-top box 102 includes a processing module 254 coupled to memory 250, which interacts with the components of the set-top box 102 through the local bus 262.

The processing module 254 is coupled to retrieve operation instructions from the memory 250 that cause the processing module to solicit opinion feedback in a computer-based social network, as discussed in further detail with reference to FIGS. 3-6. In pursuing the opinion feedback, the processing module 104 may perform one or more graphic functions upon the captured visual image signal 122. The graphic functions include compositing, aliasing, pixel definition, imaging techniques such as skeletal visualization, et cetera.

Further note that the processing module 254 may be implemented using a shared processing device, individual processing devices, or a plurality of processing devices and may further included associated memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory 250 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 254 implements one or more of its functions via a state machine, analog circuitry, digital circuitry, and/or logic circuitry, the memory 250 storing the corresponding operational instructions is embedded with the circuitry that includes the state machine, analog circuitry, digital circuitry, and/or logic circuitry.

FIG. 3 is an illustration of a display screen 120 having a first graphic user interface (GUI) 302 and a second GUI 3. The first GUI 302 has a first portion 310 and a second portion 314. Though the display screen 120 of FIG. 3, an individual is able, through the mirrored-representation 126, produce an adorned mirrored-representation 318 through identified items, such as identified items 340 and 336 of the second GUI 306. Identified items can also be provided locally to the first GUI 302.

The first portion 310 of the first GUI 302 displays graphic based objects 304 and 316, which the individual sets aside, or provides a staging area, for adorning the mirrored-representation of the individual to produce the adorned mirrored-representation 318. The graphics based object 304 includes metadata 308, including, for example, source₂ of the object, purchase information₂ of the object, and a graphic depiction of the object. In the example provided, the graphics based object 304 depicts a hat. The graphics based object 312 includes metadata 312, including, for example, source₁ of the object, and purchase information₁ of the object, and a graphic depiction of the object. In the example provided, the graphics based object 312 depicts a desktop computer.

The second portion 314 of the first GUI 302 displays an mirrored-representation 318. For clarity, the mirrored-representation is shown as a mannequin; however, as one of ordinary skill in the art may appreciate, a lifelike depiction of the individual 128 as captured by the image capture device 124 (see FIG. 1) can be used.

The mirrored-representation 126 may also be implemented as an image skeleton 324, in which a series of ‘bones,’ or ‘rigging’ is used in the depiction. Each bone of the image skeleton 324 includes a three dimensional transformation (position, scale and orientation), and an optional parent bone to form a rigging hierarchy. For example, thigh-bone will move the lower leg too. As the character is animated, the rigging changes over time, under the influence of positional reference and motion by the individual 128. The image skeleton 324 may provide further depictions of the individual 128, such as providing “skin” pattern overlays of the image skeleton 324.

In the example provided by FIG. 3, the mirrored-representation is adorned with the identified item 352, based upon the graphics based object 304. In populating the first portion 310 with graphics based objects, the individual 128 (see FIG. 1) identifies an item of a plurality of items by a motion gesture, which in turn, in substantially real-time, the mirrored-representation 126 mimics with the motion gesture 320 to identify the item.

In generating the motion gesture 320, the set-top box 102 senses an emphasis in gesture, such as accelerated movement of a hand, a foot, or other limbs of the individual. Further, the motion gesture 320 may be sensed by a handheld accelerometer device, a tilt sensor, a combination of an accelerometer device and tilt sensor, etc., that the senses the motion of a hand, and further can be used to grasp the identified item 340 with a further input, such as a button press, etc.

The mirrored-representation 126 mimics the gesture of the individual, providing feedback through a pointer 344, highlighting 346, or other indication of the identified item 352, as shown in the second GUI 306. With the identification of an item, the individual, through a further motion gesture, drags, as indicated by drag indication 336, the identified item 340 to the first portion 310 of the first GUI 302. The scale of the identified item 352 is adjusted to correspond to the scale of the second portion 314 via a compositing process, such as that of the 2D/3D graphics engine and compositor 222 (see FIG. 2).

When the first GUI 302 and the second GUI 306 overlap, the overlapping portions, such as overlapping portion 348, are sufficiently opaque to permit the identification of the item of the plurality of items by the mimicked motion gesture 320 through the mirrored-representation 126 of the individual 128.

With the first portion 310, an individual adorns the mirrored-representation 126 with identified items, such as identified item 352. Further, mirrored-representation 126 may be adorned by items placed in the virtual room 326 defined by the second portion 314. For example, furniture 330 occupies the virtual room 326, based upon the interests and styles of the individual 128.

Further, command options 404, 408, 412, 416 and 420 are presented to the individual 128, which are based upon the identified item considered or highlighted, or a plurality of identified items. For example, as the furniture 330 may be a purchased item, that is, virtually purchased and/or physically possessed, by the individual. For example, one command option when the furniture 330 is selected is to delete the item. Also, the individual may remove the object for the furniture 330 to the first portion 310.

In another scenario, when identified items adorn the mirrored-representation to test item coordination such as color, style, fit, et cetera, further options are presented, such as a wish option 404 to place in a virtual shopping cart for future purchase (or purchase by others as a gift), a delete option 408 to discard the item, a cart option 412 to ready the item for purchase, a buy option 416 to purchase the item outright, and a compare option 420 to compare the item and price with other vendors identified in the purchase information of the metadata 308 or 316.

Further, the second GUI 306 may provide items offered for sale by third-party vendors. In this respect, the individual 238 is not constrained to items within the first GUI 302, which would generally have been limited to single third-party vendor that operates the web site.

For example, with respect to an identified item of a plurality of items posted on the second GUI 306, the processing module 254 of the set-top box 102 retrieves operational instructions from the memory 250, which cause the processing module 254 to determine whether the identified item 352 of the plurality of items is subject to manipulation by the motion gesture 320. When the identified item 352 is not subject to manipulation by the motion gesture 302, the operational instructions cause the processing module 254 to define a graphics-based object 304 for the identified item 352. As discussed earlier, the graphics-based object 304 includes metadata 308 describing aspects of the graphics-based object 304, including source and purchase information for the identified item 352.

With the defined graphics based object 304, the identified item 352 can be manipulated by the individual 128 with a gesture motion 320 as mimicked through the mirrored-representation 126. The identified item 352 is then dragged, based upon a corresponding motion gesture, from the second GUI 306 to the first GUI 310. The graphics based object 304 is then available to adorn the mirrored-representation 126. In the alternative, upon creation of the graphics based object 398, the operational instructions cause the processing module 254 to place the graphics based object 398 in the first portion 310 without further instruction requests or requirements to the individual 128. The graphics based object 304 is also subject to three-dimensional rendering of the object. The three-dimensional rendering may be a conversion process based upon a two-dimensional object, or based upon information or data provided with a graphics based object.

FIG. 4 is an illustration of the display screen 120 having the first GUI 302 posted to a computer-based social network 328 for opinion feedback. The individual 128, upon creating an adorned mirrored-representation 318, posts the virtual room 326 to the computer-based social network 328 to receive, in response to the posting, opinion feedback relating to the adorned mirrored-representation 318 from friends, like-minded people with similar social profile 366, et cetera. Examples of computer-based social networks include facebook, athlinks, badoo, epernicus, eons, kiwibox, et cetera.

To post the virtual room 328, including the virtual contents of the room and the adorned mirrored-representation 318, the individual 128 (see FIG. 1), is posted upon selection of the share option 394, which may be selected by a motion gesture 384 mimicked by the adorned mirrored-representation 318, by a pointer click, et cetera.

To receive opinion feedback from like-minded people, the individual 128 (see FIG. 1) has a social profile 366 including fields with information as name, nickname, interest(s), friends-of-a-friend (FOAF), a graphic depiction 368, et cetera.

The individual 128 receives opinion feedback as a text message-based feedback 374, an anonymous vote feedback 370, and/or by a third-party adornment with another identified item 362.

The text message-based feedback 374 is posted via a text board 378, where friends are identified by their screen names, such as Joyce, Jamie, et cetera. Response by the individual 128 is available by typing responses within the text box 382 and posting to the computer-based social network 328. Further feedback examples could request the individual to move in the virtual room 326 to show other angles of the identified item 352.

The anonymous vote feedback 370 may be based upon a sub-group of friends or like-minded individuals, with the anonymity based upon a vote tally 382. The vote tally can be presented for the identified items selected by the user, such as the identified item 352, and that another identified item 362. The vote tally 382 includes ‘yes’ and ‘no’ tallies to indicate the general approval trend of certain items.

As a further form of social feedback, a third-party may adorn the mirrored-representation 318 by posting another graphics based object 398 to the first portion 310 of the first GUI 302. The first portion 310 serves as staging area of items under consideration by the individual 128, and may be used to further adorn the mirrored-representation 318.

The individual may accept the graphics based object 398 with an accept option 386, or decline with a decline option 390. Acceptance of the graphics based object 398 would place it in the first portion 310, and subsequently may further adorn the mirrored-representation 318 by the third-party, or optionally by the individual 128. With the acceptance of the graphics based object 398, metadata 356 is provided that includes source, purchase, and status information. Command options 303, 308, 312, 316 and 420 are also available to the accepted graphics based object 398.

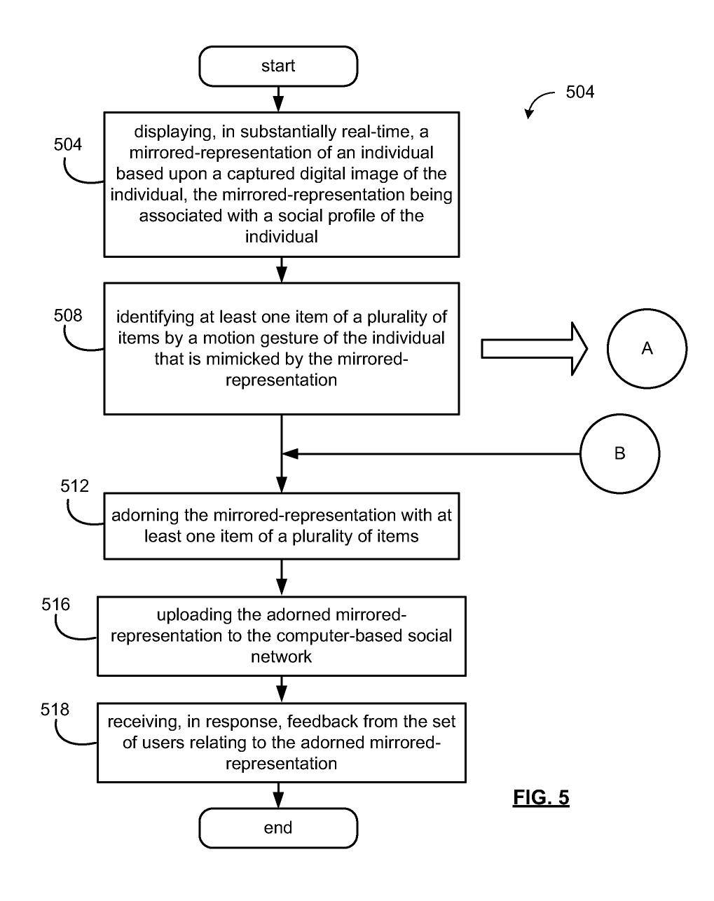

FIG. 5 illustrates a method 500 for soliciting opinion feedback in a computer-based social network. The method begins at step 504 as displaying, in substantially real-time, a mirrored-representation of an individual based upon a captured digital image of the individual. The mirrored-representation of the individual may be captured by video camera, a digital camera, a high-definition camera, a web cam, et cetera (see FIG. 1). The mirrored-representation is associated with a social profile of the individual so that other participants to the social network with similar interests may interact through the social network.

At step 508, the individual identifies an item of a plurality of items, wherein the mirrored-representation mimics a motion gesture of the individual to identify the item. The plurality of items can include clothing, clothing accessories, room furnishings, furnishing decor, et cetera, that may adorn the mirrored-representation of the individual by placing on the mirrored-representation or the virtual room of the mirrored-representation.

The individual, at step 512, adorns the mirrored-representation with the identified item of the plurality of items, and at step 516, uploads the adorned mirrored-representation to the computer-based social network. The upload of the adorned mirrored-representation may include the virtual room with the adorned mirrored-representation.

At step 518, the individual receives, in response to the posting, opinion feedback relating to the adorned mirrored-representation, where the opinion feedback from at least a subset of a set of users. The feedback may include text message-based feedback, anonymous vote feedback, third party adornment with another identified item, et cetera.

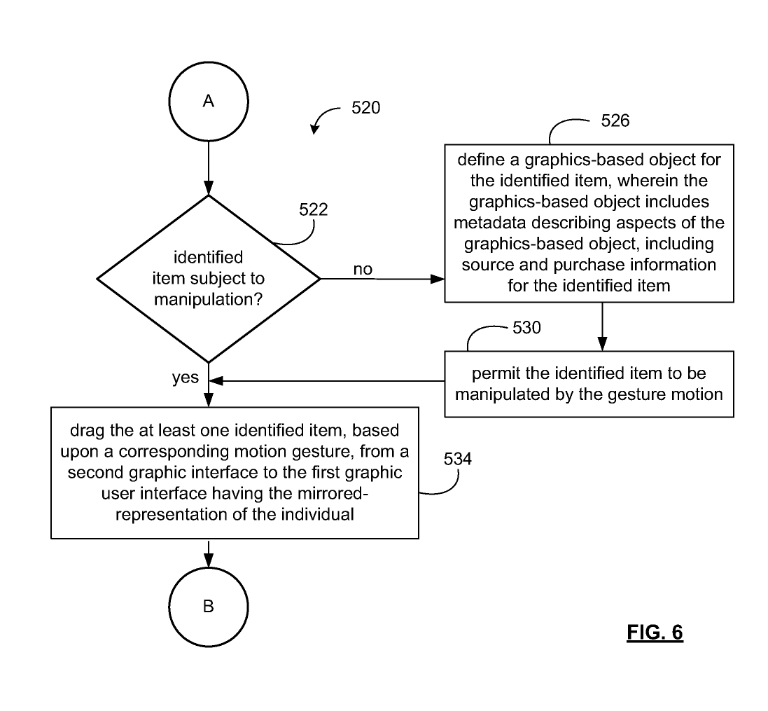

With respect to identifying at least one item of a plurality of items by a motion gesture of an individual at step 508, a determination may be made regarding whether the identified item is subject to manipulation, which is discussed in detail with respect to FIG. 6.

FIG. 6 illustrates a method 520 for determining whether an identified item is subject to manipulation by the individual through the mirrored-representation. At step 522, the method 520 determines whether an identified item of a plurality of items is subject to manipulation. Such an instance may occur in a multiple GUI configuration that includes GUIs sponsored by other third-parties, including vendors, sponsors, et cetera. In that regard, the identified item may not be subject to manipulation, and accordingly, may in itself not be susceptible to adoring the mirrored-representation to present a virtual reflection of the individual.

When the identified item is not subject to manipulation, then at step 526, the method defines a graphics-based object for the identified item, wherein the graphics-based object includes metadata describing aspects of the graphics-based object, including source and purchase information for the identified item.

When the identified item is subject to manipulation, then at step 534, the individual is permitted to manipulate the identified item with a gesture motion, placing or dragging the object to the GUI of the mirrored-representation of the individual. The method 520 returns to step 512 of the method 500 of FIG. 5.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (that is, where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that a first signal has a greater magnitude than a second signal, a favorable comparison may be achieved when the magnitude of the first signal is greater than that of the second signal or when the magnitude of the second signal is less than that of the first signal.

What is claimed is:

1. A method for soliciting opinion feedback in a computer-based social network, the computer-based social network populated by a set of users defined by social profiles indicating shared interests with an individual, the method comprising:
displaying, in substantially real-time, a mirrored-representation of the individual based upon a captured digital image of the individual, the mirrored-representation being associated with a social profile of the individual;
identifying an item of a plurality of items, wherein the mirrored-representation mimics a motion gesture of the individual to identify the item;
adorning the mirrored-representation with the identified item of the plurality of items;
uploading the adorned mirrored-representation to the computer-based social network; and
receiving, in response, opinion feedback relating to the adorned mirrored-representation from at least a subset of the set of users.

2. The method of claim 1 wherein the displaying, in substantially real-time, the mirrored-representation of the individual further comprising:
capturing a visual image of the individual with an image capture device;
generating the mirrored-representation of the visual image in a first graphic user interface;
displaying, via a display, the mirrored-representation of the individual in the first graphic user interface.

3. The method of claim 2 further comprising:
a second graphic user interface, wherein the plurality of items are displayed in the second graphic user interface.

4. The method of claim 3 wherein,
when the first graphic user interface and the second user graphic interface overlap, the overlapping portions of the first and the second user graphic interfaces are sufficiently opaque to permit the identification of the item of the plurality of items by the mimicked motion gesture by the mirrored-representation of the individual.

5. The method of claim 4 wherein identifying the item of the plurality items by the motion gesture of the individual comprising:
determining whether the identified item of the plurality of items is subject to manipulation by the motion gesture;
when the identified item is not subject to manipulation by the motion gesture,
defining a graphics-based object for the identified item, wherein the graphics-based object includes metadata describing aspects of the graphics-based object, including source and purchase information for the identified item, and
permitting the identified item to be manipulated by the gesture motion; and
dragging the identified item, based upon a corresponding motion gesture, from the second graphic interface to the first graphic user interface having the mirrored-representation of the individual.

6. The method of claim 1 wherein the opinion feedback comprises at least one of:
feedback by third-party adornment of the mirrored-representation with another identified item;
text message feedback; and
anonymous vote feedback.

7. The method of claim 1 wherein displaying, in substantially real-time, the mirrored representation of the individual based upon a captured digital image of the individual further comprises:
a virtual room that includes a mirrored-representation of at least one user of the set of users.

8. The method of claim 1, wherein each of the social profiles comprises:
a unique identifier; and
at least one of:
a name;
a nickname;
a graphic depiction;
an interest; and
a friend-of-a-friend (FOAF).

9. The method of claim 1 wherein adorning the mirrored-representation with the item of the plurality of items further comprising
presenting command options based upon the at least one item, the command options selectable by gesture motion input by the individual.

10. The method of claim 9, wherein the command options comprise at least one of:
purchase transaction command;
holding queue command;
remove command;
wishlist command; and
price comparison command.

11. The method of claim 1, wherein the plurality of items comprise at least one of:
clothing;
clothing accessories;
room furnishings; and
furnishing decor.

12. A set-top box device to solicit opinion feedback in a computer-based social network, the computer-based social network populated by a set of users defined by social profiles indicating shared interests with an individual, the set-top box device comprises:
a processing module;
memory operably coupled to the processing module, wherein the memory stores operational instructions that cause the processing module to:
display, in substantially real-time, a mirrored-representation of the individual based upon a captured digital image of the individual, the mirrored-representation being associated with a social profile of the individual;
identify an item of a plurality of items, wherein the mirrored-representation mimics a motion gesture of the individual to identify the item;
adorn the mirrored-representation with the identified item of the plurality of items;
upload the adorned mirrored-representation to the computer-based social network; and
receive, in response, opinion feedback relating to the adorned mirrored-representation from at least a subset of the set of users.

13. The set-top box of claim 12 wherein the memory further stores operational instructions that cause the processing module to display, in substantially real-time, the mirrored-representation of the individual by:
capturing a visual image of the individual by a digital camera;
generating the mirrored-representation of the visual image in a first graphic user interface;
displaying, via a display, the mirrored-representation of the individual in the first graphic user interface.

14. The set-top box of claim 13 wherein the memory further stores operational instructions that cause the processing module to further generate:
a second graphic user interface, wherein the plurality of items are displayed in the second graphic user interface.

15. The set-top box of claim 14 wherein the memory further stores operational instructions that cause the processing module to:
when the first graphic user interface and the second user graphic interface overlap, the overlapping portions of the first and the second user graphic interfaces are sufficiently opaque to permit the identification of the item of the plurality of items by the mimicked motion gesture by the mirrored-representation of the individual.

16. The set-top box of claim 15 wherein the memory further stores operational instructions that cause the processing module to identify the item of the plurality items by the motion gesture of the individual by:
determining whether the identified item of the plurality of items is subject to manipulation by the motion gesture;
when the identified item is not subject to manipulation by the motion gesture,
defining a graphics-based object for the identified item, wherein the graphics-based object includes metadata describing aspects of the graphics-based object, including source and purchase information for the identified item, and
permitting the identified item to be manipulated by the gesture motion; and
dragging the identified item, based upon a corresponding motion gesture, from the second graphic interface to the first graphic user interface having the mirrored-representation of the individual.

17. The set-top box of claim 12 wherein the opinion feedback comprises at least one of:
feedback by third-party adornment of the mirrored-representation with another identified item;
text message feedback; and
anonymous vote feedback.

18. The set-top box of claim 12 wherein the memory further stores operational instructions that cause the processing module to display, in substantially real-time, the mirrored representation of the individual based upon a captured digital image of the individual by:
a virtual room that includes a mirrored-representation of at least one user of the set of users.

19. The set-top box of claim 12, wherein each of the social profiles comprises:
a unique identifier; and
at least one of:
a name;
a nickname;
a graphic depiction;
an interest; and
a friend-of-a-friend (FOAF).

20. The set-top box of claim 12 wherein the memory further stores operational instructions that cause the processing module to adorn the mirrored-representation with the at least one item of the plurality of items by:
presenting command options based upon the at least one item, the command options selectable by gesture motion input by the individual.
